(19) United States
(12) Patent Application Publication
(10) Pub. No.: US 2006/0164638 A1
(43) Pub. Date: Jul. 27, 2006

(54) Near-field film-thickness measurement apparatus

(75) Inventor: Yoshihito Narita, Hachioji-shi (JP)

Correspondence Address: RANKIN, HILL, PORTER & CLARK, LLP, 925 EUCLID AVENUE, SUITE 700, CLEVELAND, OH, 44115-1405, US

(73) Assignee: Jasco Corporation, Hachioji-shi (JP)

(21) Appl. No.: 11/318,781

(22) Filed: Dec. 27, 2005

(30) Foreign Application Priority Data
Dec. 28, 2004 (JP) 2004-380175

(51) Int. Cl. G01J 3/30; H01J 3/14

(52) U.S. Cl. 356/318; 250/234

(57) ABSTRACT

A near-field film-thickness measurement apparatus having a spatial resolution at or below the wavelength of light and having sufficient film-thickness measurement precision. The near-field film-thickness measurement apparatus 10 comprises a scattering near-field probe 12, a light source 14, a detector 18, a spectroscope 16 disposed in an optical path between the light source 14 and the detector 18, and a film-thickness calculating unit 20. The light source 14 emits excitation light for generating near-field light at a tip of the near-field probe 12 and/or at a surface of a film sample. The detector 18 detects, as measurement light, scattered light generated by bringing the tip of the near-field probe 12 and the surface of the film sample close to the region of the near-field light. The spectroscope 16 performs spectrometry in a predetermined range of wave numbers. The film-thickness calculating unit 20 calculates the film thickness of the film sample based on spectral information obtained from the measurement light detected at the detector 18.

### RELATED APPLICATIONS

This application claims priority to the Japanese Patent Application 2004-380175 dated on Dec. 28, 2004 and is hereby incorporated with reference for all purposes.

### BACKGROUND OF THE INVENTION

1. Field of the Invention

The present invention relates to film-thickness measurement apparatuses, and in particular to an improvement in the spatial resolution thereof.

2. Description of the Related Art

There have been conventionally used film-thickness measurement apparatuses for non-contact, non-destructive measurement of the film thickness of film samples using optical interference. Such apparatuses use microscope spectrometers and so forth to measure the interference spectrum due to light reflected from the front surface and rear surface of the film and obtain the film thickness (for example, see Japanese Unexamined Patent Application Publication No. H05-302816 and Japanese Unexamined Patent Application Publication No. H07-4922). For instance, the film thickness d can be calculated from the waveform of the interference spectrum based on equation (1) below.

$$d = \frac{N}{2 \sqrt{{n}^{2} - {sin}^{2} θ} \cdot Δ v} \qquad ( 1 )$$

wherein, Δv(=v₂−v₁) is the difference between the wave number v₁ at a peak (maximal point) in the interference spectrum and the wave number v₂ at a different peak (maximal point), N is the number of valleys (minimal points) included between the wave numbers v₁ and v₂, n is the refractive index of the film sample, and θ is the angle of incidence of the light.

The film-thickness measurement apparatuses described above are not capable of performing measurement at a scale smaller than the wavelength of the light used for measurement, as standard optical measurement apparatuses. In other words, like other optical measurement apparatuses, the spatial resolution is limited by the diffraction limit of light. Accordingly, as disclosed in Japanese Unexamined Patent Application Publication No. 2004-264118, a film-thickness measurement apparatus using near-field optics has been proposed.

The apparatus disclosed in Japanese Unexamined Patent Application Publication No. 2004-264118 performs measurement in a so-called illumination-collection mode using an aperture-type near-field probe. That is, near-field light is emitted from a minute aperture in the probe to illuminate the sample, and scattered light due to the interaction between the near-field light and the sample passes through the aperture-again and is collected.

However, when performing interference measurement with the apparatus using the aperture-type probe disclosed in Japanese Unexamined Patent-Application Publication No. 2004-264118, simple reflected light from the aperture portion of the probe or a connection part for connecting the probe and an optical fiber and simple reflected light from the upper surface and the lower surface of the thin-film serving as the object under measurement enter the detector. In general, such simple reflected light, particularly the simple reflected light from the probe aperture or the connection part of the optical fiber, is several orders of magnitude more intense than the interference light from the thin film serving as the object under measurement, and therefore, the detection sensitivity of the interference light is drastically reduced. In addition, because interference light generated at an angle with respect to the film is also detected, the measurement accuracy of the film thickness is further reduced.

### SUMMARY OF THE INVENTION

The present invention has been conceived in light of the problems described above, and an object thereof is to provide a near-field film-thickness measurement apparatus having a spatial resolution at or below the wavelength of light and having sufficient film-thickness measurement precision.

A near-field film-thickness measurement apparatus of the present invention comprises a scattering near-field probe, a light source, a detector, a spectroscope disposed in an optical path between the light source and the detector, and a film-thickness calculating unit. The light source emits excitation light for generating near-field light at a tip of the near-field probe and/or at a surface of a film sample. The detector detects, as measurement light, scattered light generated by bringing the tip of the near-field probe and the surface of the film sample close to the region of the near-field light. The spectroscope performs spectrometry in a predetermined range of wave numbers. The film-thickness calculating unit calculates the film thickness of the film sample based on spectral information obtained from the measurement light detected at the detector.

In the near-field film-thickness measurement apparatus of the present invention, it is preferable that the apparatus further comprises a moving mechanism for moving the position of the tip of the near-field probe over a measurement surface of the film sample to change the measurement position and measure the film-thickness distribution of the film sample.

In the near-field film-thickness measurement apparatus of the present invention, it is preferable that the detector is disposed at the position of a dark field with respect to the positional relationship between the light source and the tip of the near-field probe.

### BRIEF DESCRIPTION OF THE DRAWINGS

FIG. 1 roughly shows the configuration of a near-field film-thickness measurement apparatus according to an embodiment of the present invention.

FIG. 2 is a diagram depicting film-thickness measurement using near-field light.

FIG. 3 is a sketchy graph showing an interference spectrum.

FIG. 4 is a diagram depicting the optical alignment of the near-field film-thickness measurement apparatus according to the present embodiment.

FIG. 5 is a graph showing the results obtained by measuring a film-thickness distribution with the near-field film-thickness measurement apparatus according to the present embodiment.

FIGS. 6A, 6B, and 6C are graphs showing the spectra obtained at different positions of a film sample.

### DESCRIPTION OF THE PREFERRED EMBODIMENT

A preferred embodiment of the present invention will be described below with reference to the drawings.

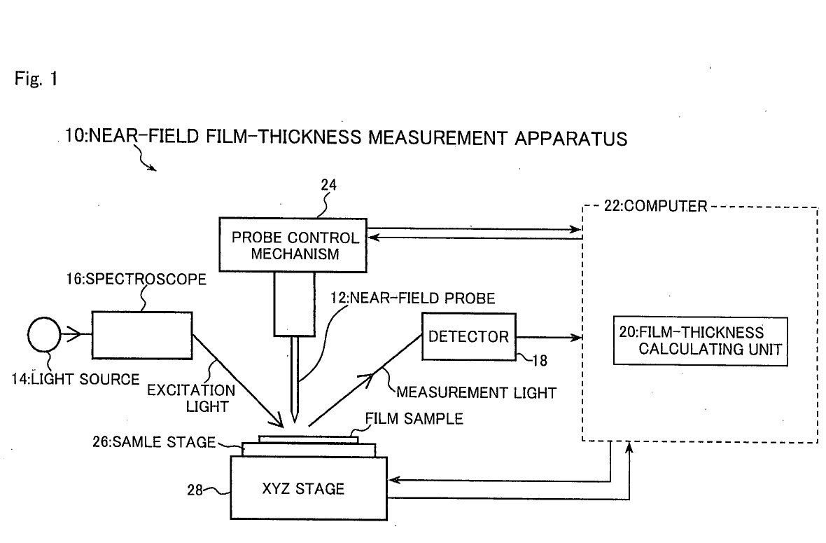

FIG. 1 roughly shows the configuration of a film-thickness measurement apparatus according to an embodiment of the present invention. The film-thickness measurement apparatus 10 in FIG. 1 includes a scattering near-field probe 12, a light source 14 for emitting excitation light for generating a near-field, a spectroscope 16 for wavelength scanning, a detector 18 for detecting the light scattered by the tip of the near-field probe 12 as measurement light, and a film-thickness calculating unit 20 for calculating the film thickness of a film sample from the spectrum of the measurement light.

The excitation light emitted from the light source 14 passes through the spectroscope 16 for wavelength scanning and irradiates the tip of the near-field probe 12 and/or the surface of the film sample. Near-field light that is localized-near the tip of the near-field probe 12 and/or on the surface of the film sample is generated by the irradiated excitation light. The tip of the near-field probe 12 is brought close to the surface of the film sample so that the surface of the film sample is located within the near-field region generated in the vicinity of the tip of the near-field probe 12 or so that the tip of the near-field probe 12 is located within the near-field region generated in the vicinity of the surface of the sample film, and the measurement light generated by scattering of the near-field light is detected with the detector 18. A signal from the detector 18 is sent to a computer 22, and the film thickness of the film sample is obtained by the film-thickness calculating unit 20 inside the computer 22 from the spectral information of the measurement light. In the present embodiment, the film-thickness calculating unit 20 is realized by a program that the computer 22 executes.

The near-field probe 12, which is of the scattering type, is tapered at the tip thereof so that the radius of curvature of the tip is equal to or less than the wavelength of light. A probe formed of dielectric material or metal, or a probe formed by processing an optical fiber or the like to coat a metallic film, such as a gold film, on the surface thereof is generally used.

The distance between the tip of the near-field probe 12 and the sample surface is controlled using a probe control mechanism 24. This distance control is carried out based on shear-force control or the like.

In the present embodiment, an infrared-light source is used as the light source 14, an interferometer is used as the spectroscope 16, and Fourier transform spectrometry is employed. However, the present embodiment is not limited thereto, and another type of spectroscope may be uised. Furthermore, although the present embodiment has a configuration in which the spectroscope 16 is disposed in the optical path between the light source 14 and the film sample, it may have a configuration in which the spectroscope 16 is disposed in the optical path between the film sample and the detector 18.

It is preferable to use an incoherent light source (for example, an incandescent light source or a halogen light source) as the light source 14. Use of a coherent light source, such as a pulsed laser, may cause problems such as burning of the sample, if the sample is an ordinary organic material, because the light intensity of the pulses is extremely high. With an incoherent light source, however, such problems do not arise, and it is thus possible to carry out non-contact, non-destructive measurement regardless of the type of sample.

The measurement light from the vicinity of the tip of the near-field probe 12 is detected by the detector 18, and the detection signal is sent to the computer 22. In the computer 22, the detection signal (interferogram data) is Fourier transformed to obtain spectral data for the measurement light. Based on this spectral data, the film thickness of the sample is determined in the film-thickness calculating unit 20.

The film sample is mounted on a sample stage 26. The sample stage 26 is mounted on an XYZ stage (moving mechanism) 28 for moving the tip position of the near-field probe 12 over the surface of the film sample. A film-thickness distribution is measured by moving the tip position of the near-field probe 12 to change the measurement position on the surface of the film sample.

Although the embodiment described above has a reflection configuration in which the excitation light is irradiated onto the tip of the near-field probe 12 and/or the surface of the sample from the same side as the near-field probe 12, the embodiment is not limited to this configuration. For example, a transmission configuration in which the tip of the near-field probe 12 is illuminated from the rear surface of the sample or a total-reflection transmission configuration in which the tip of the near-field probe 12 is illuminated by total reflection from the rear surface of the sample may be used.

An outlined configuration of the present embodiment has been described above; a description of the operation thereof will now be given below.

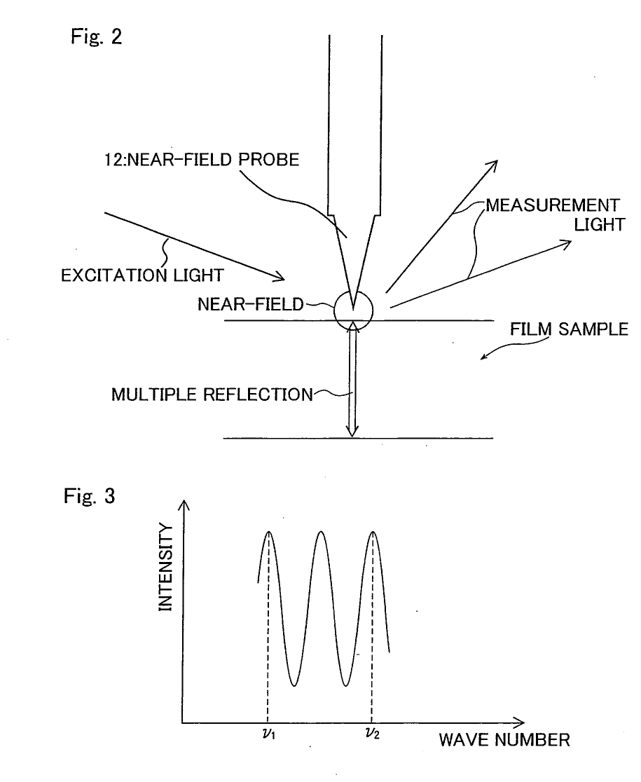

When the tip of the near-field probe 12 tapers to a size equal to or less than the wavelength of light and light is irradiated, near-field light that is localized at the tip portion is generated. As shown in FIG. 2, when the near-field probe 12 is brought close to the surface of the film sample and the surface of the film sample enters the near-field region at the tip, the near-field light in the vicinity of the probe tip is scattered and is converted to light that can propagate. This propagating light is oriented in all directions, but of this light, only the light propagating directly downwards (that is, in the direction perpendicular to the film sample) the near-field probe 12 experiences multiple reflections inside the film sample (at the upper and lower surfaces of the film sample), as indicated by the double-sided arrow in FIG. 2. As a result, light leaking out from the film surface (near-field light) is re-scattered at the tip of the near-field probe 12 and is directed towards the detector 18. This light is detected by the detector 18 as measurement light. This measurement light includes information about the light that underwent repeated multiple reflections in the vertical direction inside the film; therefore, by analyzing its spectrum, it is possible to obtain information about the film thickness. Furthermore, among the propagating light described above, the light which is not normal to the film sample is repeatedly reflected inside the film sample but does not reach the detector 18.

The measurement light described above is detected at the detector 18, and the detection signal is sent to the computer 22. In the computer 22, predetermined data processing is performed on the detection signal to obtain the spectrum of the measurement light, as described above. Then, the film thickness of the film sample is determined by the film-thickness calculating unit 20 from the spectral information. In other words, predetermined filtering processing is carried out on the measurement light spectrum to extract an interference spectrum component, and the film thickness is determined from the period of this interference spectrum. The calculation of the film thickness described above may be based on known techniques in the art (for example, see Japanese Unexamined Patent Application Publication No. H05-302816 and Japanese Unexamined Patent Application Publication No. H07-4922). For example, the film thickness is obtained from the interference spectrum shown roughly in FIG. 3 using the expression shown in equation (1) above. As explained above, the angle of incidence θ can be set to zero. Therefore, the film thickness d can be obtained from equation (2) shown below.

$$d = \frac{N}{2 n \cdot Δ v} \qquad ( 2 )$$

where, Δv(=v₂₋ᵥ₁) is the difference between the wave number v, at a peak (maximal point) in the interference spectrum and the wave number v₂ at a different peak (maximal point), N is the number of valleys (minimal points) between the wave numbers v₁ and v₂ described above, and n is the refractive index of the film sample.

With an apparatus using an aperture-type probe, as described in Japanese Unexamined Patent Application Publication No. 2004-264118, there is an excessive drop in detection sensitivity of the interference light due to the background (for example, simple reflected light from the probe aperture or the like, simple reflected light from a connecting portion between the probe and an optical fiber for guiding light thereto, and simple reflected light from the film sample) and there is a drop in measurement accuracy of the film thickness caused by detecting the interference light due to light incident at an angle with respect to the film (light other than normally incident light).

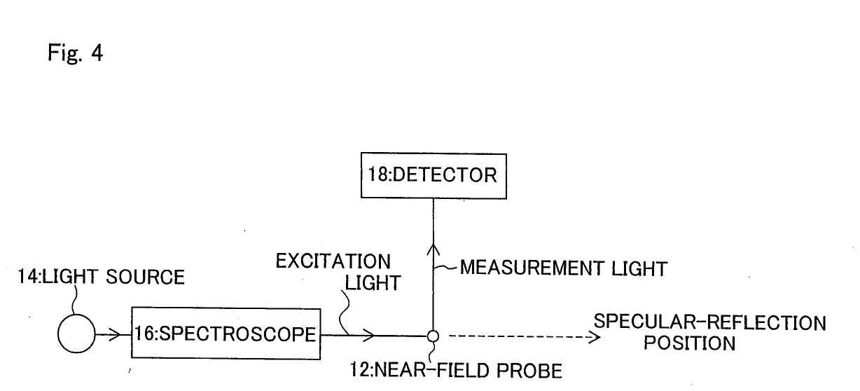

In order to overcome the problems with such an apparatus using an aperture-type probe, a scattering probe is used in the present embodiment, and furthermore, by suitably designing the optical alignment, the above-described background can be significantly reduced. FIG. 4 is a diagram depicting the optical alignment of the near-field film-thickness measurement apparatus of the present embodiment. FIG. 4 shows the optical alignment of the light source 14 (and the spectroscope 16), the near-field probe 12, and the detector 18, as viewed from the probe axis direction. The problems described above occur when the light source, the probe tip, and the detector are aligned in a straight line. For example, in Japanese Unexamined Patent Application Publication No. 2004-264118, an aperture portion of the probe functions as both an illumination part and a light-collecting part (detector), and the probe aperture (illumination part), the film sample, and the probe aperture (light-collecting part) are arranged in a straight line. In contrast, in the present embodiment, the detector 18 is disposed at a dark field position with respect to the positional relationship between the light source 14 and the tip of the near-field probe 12, as shown in FIG. 4. That is, the detector 18 is disposed such that the light source 14 and the detector 18 are not in a specular-reflection positional relationship with respect to the film sample (or the tip of the near-field probe 12). When using a transmission configuration in which the excitation light is irradiated from the rear surface of the sample, the detector 18 needs to be disposed at a position where the light transmitted through the film sample is not directly incident on the detector 18. In the present embodiment, as shown in FIG. 4, viewed from the probe axis direction, the detector 18 is disposed so that the line joining the detector 18 and the tip of the near-field probe 12 is perpendicular to the line joining the light source 14 and the tip of the near-field probe 12. With such a configuration, the background does not enter the detector 18, and therefore, it is possible to detect, with good sensitivity, only the-measurement light, containing interference information, which is generated in the vicinity of the tip of the near-field probe 12. Furthermore, interference light that departs from the direction orthogonal to the film does not enter the detector 18, and therefore, only interference light in exactly the normal-incidence direction with respect to the film is detected (with a degree of angular error allowed for in the magnitude of the radius of curvature of the probe tip). As a result, the film thickness can be measured with superior accuracy.

Furthermore, in the present embodiment, there is no limit to the range of wave numbers transmittable by the optical fibers, which is likely to be imposed on aperture-type probes, and it is possible to obtain the spectrum over a wide range of wave numbers. More specifically, for a small film thickness, the interference period of the interference spectrum is long, it may be unable to measure it in the range of measurement wave numbers of the aperture-type probes. However, with a scattering probe such as that used in the present embodiment, because it is possible to measure the interference spectrum over a wide range of wavelengths, there is no such restriction.

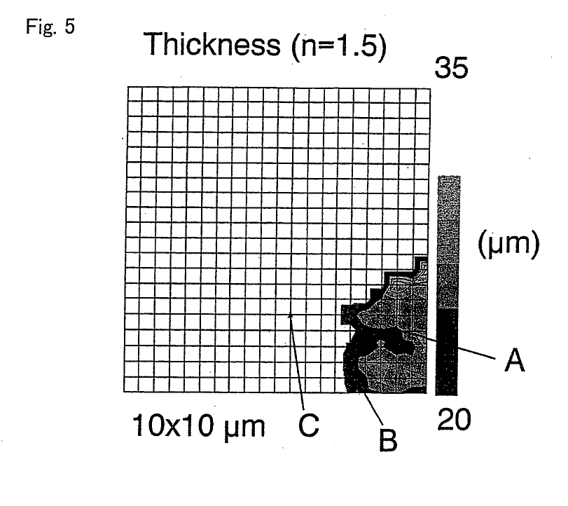

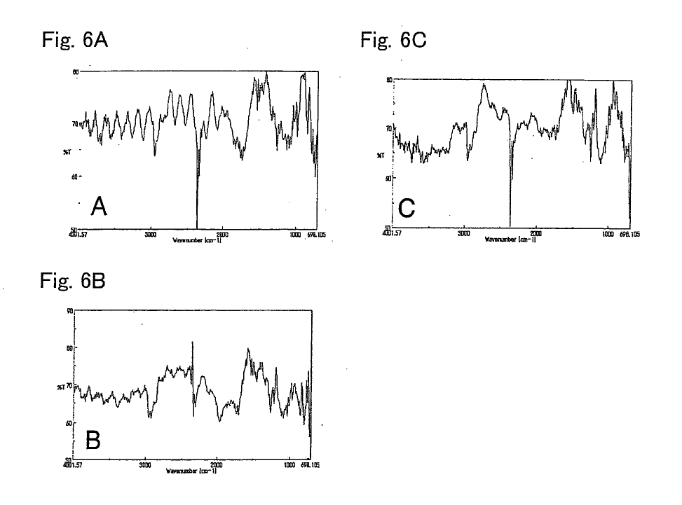

FIG. 5 is a mapping diagram showing the results of measuring the film-thickness distribution with the near-field film-thickness measurement apparatus described above. The film-thickness distribution is displayed in a color-coded manner. FIGS. 6A, 6B, and 6C show measurement spectra obtained at points A, B, and Cl, respectively, in the mapping diagram in FIG. 5. The mapping diagram in FIG. 5 shows the film-thickness distribution in a 10×10 μm region of the surface of the film sample, in which mica particles are dispersed in an organic solvent. An interference spectrum is extracted from the spectrum for each point (see FIGS. 6A to 6C), and the film thickness is calculated assuming an average refractive index n of 1.5 for the film sample. As can be understood from this mapping diagram, the spatial resolution is of the same order as the diameter of the probe tip, and it is possible to measure the film-thickness distribution with a high spatial resolution of several micrometers or less, which is smaller than the wavelength of the light used.

As described above, according to the apparatus of the present embodiment, using near-field optics enables measurement of the film-thickness distribution with a spatial resolution exceeding the diffraction limit of light. Furthermore, with the present embodiment, because a scattering near-field probe is employed, it is possible to perform film-thickness measurement with superior accuracy.

What is claimed is:

1. A near-field film-thickness measurement apparatus comprising:
a scattering near-field probe;
a light source for emitting excitation light for generating near-field light at a tip of the near-field probe and/or at a surface of a film sample;
a detector for collecting and detecting, as measurement light, scattered light generated by bringing the tip of the near-field probe and the surface of the film sample close to the region of the near-field light;
a spectroscope, disposed in an optical path between the light source and the detector, for performing spectrometry in a predetermined range of wave numbers; and
a film-thickness calculating unit for calculating the film thickness of the film sample based on spectral information obtained from the measurement light detected at the detector.

2. A near-field film-thickness measurement apparatus according to claim 1, further comprising a moving mechanism for moving the position of the tip of the near-field probe over a measurement surface of the film sample to change the measurement position and measure the film-thickness distribution of the film sample.

3. A near-field film-thickness measurement apparatus according to claim 1, wherein the detector is disposed at the position of a dark field with respect to the positional relationship between the light source and the tip of the near-field probe.
